(19) United States
(12) Patent Application Publication
(10) Pub. No.: US 2010/0264227 A1
(43) Pub. Date: Oct. 21, 2010

(54) Dual Account Transaction Card

(76) Inventor: Jared L. Joyce, Bozeman, MT (US)

Correspondence Address: Jerod E. Tufte;Tufte Law Office, PC, 106 W. Broadway, PO Box 139, Steele, ND, 58482, US

(21) Appl. No.: 12/427,181

(22) Filed: Apr. 21, 2009

(51) Int. Cl. G06K 19/00

(52) U.S. Cl. 235/493; 235/487

(57) ABSTRACT

A transaction card having two embossed account names, two embossed account numbers, two magnetic strips, an embossed expiration date, a card issuer logo, a security hologram, and a single signature block all placed in such a way that the embossed elements do not overlap the magnetic stripes or the signature bar and thus the cards may be manufactured using conventional manufacturing equipment.

### BACKGROUND OF THE INVENTION

1. Field of the Invention

This invention relates to transaction cards usable on imprint readers and on magnetic stripe readers commonly in use with conventional debit and credit cards. In particular, this invention relates to such transaction cards bearing information relating to more than one account.

2. Description of Related Art

Conventional transaction cards contain account information in a single magnetic stripe and also in characters embossed into one face of the card. Examples of such transaction cards are ATM cards, debit cards, and credit cards used in the Visa, Mastercard, American Express, and Discover networks. Conventional transaction cards can be used in magnetic-stripe readers that read the account information encoded in the magnetic stripe when the card is inserted into or passed through the reader. Conventional transaction cards may also be used in imprint machines that predate magnetic-stripe readers but remain in use. Imprint machines make a physical impression of the embossed account information onto a transaction record, generally using carbon paper or similar recording material. For a transaction card to function correctly in imprint machines, the account information including account name, account number, and expiration date must appear in raised characters. Conventional transaction card manufacturing equipment includes an embossing module that impresses characters into the card with the result that the letters are raised on the front side and correspondingly indented on the reverse side.

Modern consumers typically carry one or more ATM or debit cards and multiple credit cards, in addition to rewards cards, store-brand credit cards, identification cards and other cards of similar size and functionality. The proliferation of transaction cards increases the inconvenience to consumers in that wallets and purses must increase in size to accommodate additional cards or the consumer must select which card to carry on any given occasion. Card issuers also bear burdens related to the proliferation of cards in that the cost to produce a card and put it in the hands of a consumer continues to rise. Because cards expire or wear out over a period of two to four years, cards must be re-issued to customers. A card issuer that can simultaneously issue a debit card and a credit card or a personal credit card and a business credit card can save card manufacturing costs and also potentially save customer acquisition costs. In addition to the cost savings to manufacturers, the reduction in the number of cards has the environmental benefit of reducing the number of cards that end up in a land fill.

A solution to the proliferation of cards associated requires a different approach than the one account per card model. There have been previous attempts to address the problems of card proliferation through consolidation of multiple accounts on a single card. Some of these attempts are as follows:

U.S. Pat. No. 5,984,191 to Chapin discloses a transaction card including at least two magnetically encoded stripes having encoded account information readable by conventional transaction card reading systems. Chapin discloses a transaction card in which each magnetic stripe encodes information relating to a different account. The Chapin transaction card also has printed and optionally embossed text relating to the account name, account number, and expiration date. Each embodiment of the Chapin transaction card places embossed characters such that the indentations on the rear face of the card corresponding to the raised letters on the front face overlap with either the magnetic stripe or signature block. This is undesirable in that it is extraordinarily difficult for a person to sign the signature block if its surface contains indentations from embossed characters. In addition, a magnetic stripe will not function correctly in all card readers if the stripe is made uneven from embossing. As a result of the interference between the embossing and the magnetic stripes, the Chapin transaction card cannot be manufactured using conventional manufacturing equipment. The inability to produce the Chapin transaction card with conventional manufacturing equipment is a significant disadvantage in that a card issuer seeking to make such cards would have to first seek new custom-built manufacturing equipment from its equipment supplier before it could make the transaction cards.

U.S. Pat. No. 5,844,230 to Lalonde discloses a dual account transaction card bearing a magnetic stripe and embossed account information for each of two accounts. Lalonde recognizes the problems associated with overlapping the embossed elements with the magnetic stripe and seeks to address the problem by filling the indentations with a filler composition prior to application of the magnetic stripe. Alternatively, the stripe is simply applied over the indentations and allowed to deviate from the preferred level surface. The Lalonde card also cannot be manufactured using conventional manufacturing equipment because conventional equipment lacks a capability of inserting filler material, and more importantly, because transaction cards are manufactured in large batches. Transaction cards are generally mass-produced with all elements common to the batch of cards, such as printed information about the issuing institution, graphical elements, card issuer logos, security holograms, and magnetic stripes. The step of personalizing each card with account-specific information is performed last. This step includes encoding the magnetic stripe and embossing the account information. Because the Lalonde card requires the embossing to be performed prior to application of the magnetic stripe, it cannot be manufactured on conventional transaction card manufacturing equipment. Moreover, Lalonde's teachings relating to compensating for the inherent problems of interference between embossing and magnetic stripes suggest that those developing transaction cards had tried and failed to design a card that incorporated all required elements while still avoiding interference between embossing and elements that are incompatible with the uneven surface resulting from embossing.

### BRIEF SUMMARY OF THE INVENTION

The present invention overcomes the problems associated with prior art transaction cards. This is accomplished by a novel arrangement of embossed text characters describing the name, number, and expiration date associated with two accounts, two magnetic stripes, and one signature block that eliminates interference between these elements and thus allows the transaction cards to be manufactured on conventional manufacturing equipment. In the preferred embodiment, all embossed text characters are printed at a size of 10 characters per inch and placed on the transaction card such that no embossed text interferes with either of the two magnetic stripes or the signature block. It is an object of the present invention to provide a transaction card usable with either of two accounts thus reducing the number of cards a consumer must carry. It is a further object to provide a transaction card that may be manufactured on conventional manufacturing equipment, thus saving card issuers expense in reducing the number of cards manufactured per customer and creating an opportunity to up-sell each customer another account. For example, a bank issuing a debit card linked to a checking account may offer its customer a VISA credit card account on the same card that could be used as overdraft protection for the checking account. There continues to be market demand for transaction cards that operate with the installed base of imprint-type card readers. The transaction card of the present invention presents a novel arrangement of elements that enables two accounts on a single, standard-sized transaction card that may be conveniently used with either of the two accounts on both imprint-type and magnetic stripe card reading machines.

### BRIEF DESCRIPTION OF THE SEVERAL VIEWS OF THE DRAWINGS

FIG. 1 is a plan view of the front face of a card according to one embodiment of the invention.

FIG. 2 is a plan view of the rear face of the card of FIG. 1.

FIG. 3 is a transparent front view of the card of FIG. 1.

FIG. 4 is a front view of an alternative embodiment of the present invention.

FIG. 5 is a rear view of the alternative embodiment of FIG. 4.

FIG. 6 is a rear view of a second alternative embodiment having a front face as disclosed in FIG. 4.

### DETAILED DESCRIPTION OF THE INVENTION

The transaction card of the present invention is a transaction card of the type used in conventional debit, credit, and ATM networks and is generally depicted by the numeral 10. The transaction cards of the present invention have a size and shape that conforms to standards promulgated by the International Organization for Standardization (ISO) including ISO 7810 (relating to identity cards generally) and ISO 7813 (relating to banking cards). In compliance with these international standards, the preferred dimensions of the transaction card of the present invention is 85.60 mm wide, 53.98 mm high, and 0.76 mm thick. These standards are generally consistent with the specifications of cards issued under the authority of VISA, Mastercard, Discover, and American Express.

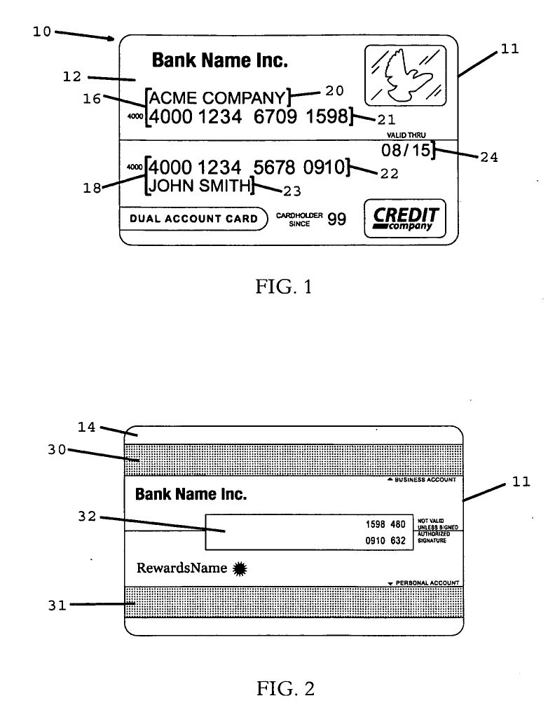

Referring specifically to FIG. 1, transaction card 10 having front face 12 includes a first information section 16 comprising embossed characters 20 and 21, a second information section 18 comprising embossed characters 22 and 23, and a third information section comprising embossed characters 24. Embossed characters 20 describe the owner or authorized user of a first transaction account. Embossed characters 21 describe the account number of said first transaction account. Embossed characters 22 describe the account number of a second transaction account. Embossed characters 23 describe the owner or authorized user of a second transaction account. Embossed characters 24 describe a date defining the period of time during which the transaction card is valid for use.

Conventional single-account transaction cards use two distinct sizes of embossed characters. The embossed characters commonly used in the industry are Farrington at seven characters per inch, and Standard Gothic at ten characters per inch. Conventional transaction cards use a character size of seven characters per inch for account numbers and ten characters per inch for the account name and expiration date. The transaction card of the present invention uses the ten characters per inch size for embossed elements 20, 21, 22, 23, and 24. By using the ten characters per inch size, compliance with imprint card readers is maintained while enabling the novel card design of the invention which allows for placement of all required embossed information for two accounts in the space normally occupied by the information for a single account.

FIG. 2 depicts the rear face 14 of the transaction card of FIG. 1. Magnetic stripe 30 is a first magnetic stripe having information relating to the first transaction account stored in it. Magnetic stripe 31 is a second magnetic stripe having information relating to the second transaction account stored in it. Magnetic stripes 30 and 31 conform in terms of length, width, position relative to the edge of the transaction card, and manner of encoding to the standards set forth in ISO 7813 and thus are operable in all conventional magnetic stripe reading machines in common use with debit, credit, and ATM cards. Signature block 32 is disposed on the rear face of the transaction card such that it is substantially centered in the vertical dimension.

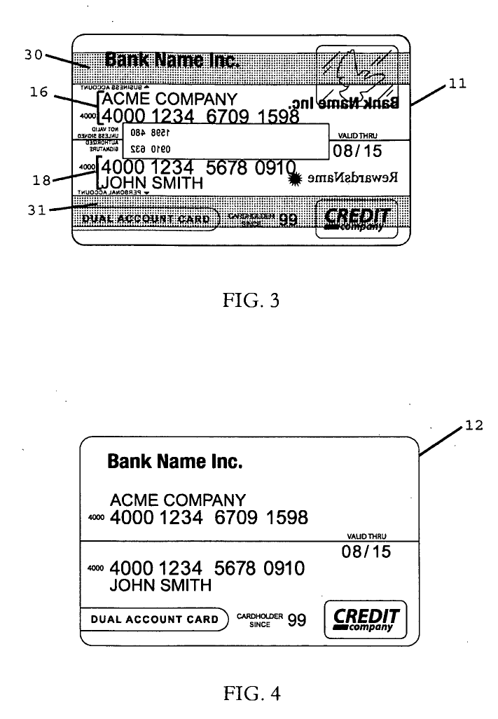

FIG. 3 depicts the transaction card of FIG. 1, showing the spatial relationship between the elements of the card using a transparent plate member 11. The depiction of a plate member 11 in transparent form more clearly illustrates the close spatial proximity of the embossed characters in information section 16 on the front face 12 and the first magnetic stripe 30 on the rear face 14, all of which relate to the first transaction account. Similarly, transparent plate member 11 illustrates the close spatial proximity of the embossed characters in information section 18 on the front face 12 and the second magnetic stripe 31 on the rear face 14, all of which relate to the second transaction account.

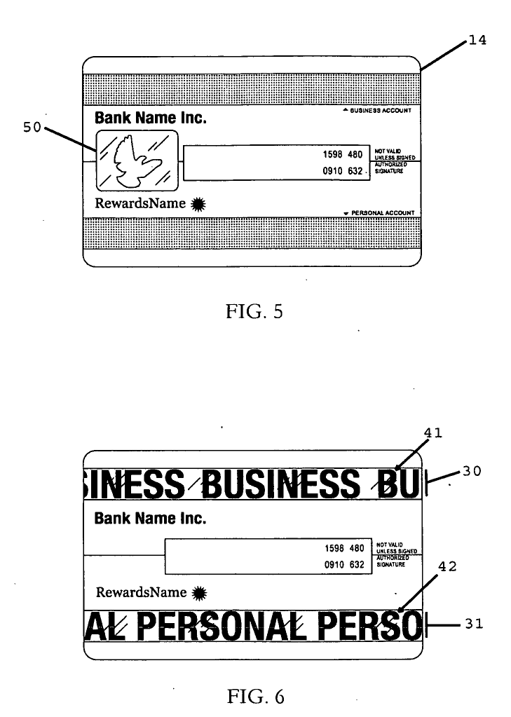

FIG. 4 depicts a front view of an alternative embodiment of the present invention. In this embodiment, the rear view of which is shown in FIG. 5, the security hologram 50 is relocated from the front face 12 of the transaction card to the rear face 14 of the transaction card. This alternative embodiment illustrates that despite the constraints of the ISO and industry regulations, transaction cards of the present invention maintain some flexibility of layout. There is some concern in the industry that placement of the security hologram relative immediately opposite magnetic stripe as shown in FIG. 3 can lead to operational problems in some card readers.

FIG. 6 depicts the rear face of a second alternative embodiment of the present invention. In this alternative embodiment, the front face is as in FIG. 4. As shown in FIG. 6, a first holographic indicia 41 is placed included within the first magnetic stripe 30 and a second holographic indicia 42 is placed within the second magnetic stripe 31. First holographic indicia 41 is comprised of characters or images that communicate an association with said first transaction account. Second holographic indicia 42 is comprised of characters or images that communicate an association with said second transaction account. As shown in FIG. 6, the first transaction account is a business account and the second transaction account is a personal account. Alternatively the holographic indicia 41 and 42 could designate account identifiers such as DEBIT and CREDIT. In either case, the usefulness of the card is enhanced by the easily recognizable indicators on the magnetic stripes 30 and 31. In many conventional transaction cards, a rectangular hologram is placed on the front of the transaction card for the purpose of making the transaction card more difficult to counterfeit. By placing a holographic indicia on magnetic stripes 30 and 31, additional space is also made available for embossed information section 16 and 18, signature block 32, and magnetic stripes 30 and 31, which as described earlier may not be in an interfering relationship if they are to be manufactured using conventional transaction card manufacturing equipment. Placement of holographic indicia 41 and 42 may be accomplished using techniques known in the art, such as those described in U.S. Pat. Nos. 4,684,795 and 5,720,500.

The transaction card of the present invention embodies a novel design distinct from prior transaction cards capable of use with more than one account. Prior art transaction cards capable of use with more than one account all suffer from the problems of either (a) the card does not work with all conventional imprint and magnetic stripe card readers for each account associated with the card or (b) the card cannot be manufactured using conventional manufacturing equipment.

A brief overview of conventional card manufacturing production techniques is necessary to explain the advantages in terms of ease of manufacturing of the present invention as compared to prior art multiple account transaction cards. Conventional transaction card manufacturing equipment produces a transaction card from four primary layers: a top laminate, a top layer, a bottom layer, and a bottom laminate. As described herein, the top layer corresponds to the front face of the transaction card and the bottom layer corresponds to the rear face of the transaction card. The four layers are bonded together in sheets from which cards in the desired dimensions are cut or punched out from the larger sheet. Magnetic stripes are placed on the sheets between the bottom laminate and the bottom layer by unspooling the magnetic stripe material from a spool or reel. In a typical single-account transaction card, only one reel is aligned with each row of cards on the sheet and thus each card has a single magnetic stripe in the conventional location adjacent the upper edge on the rear face of the card. To manufacture transaction cards of the present invention, which have two magnetic stripes per card, the only configuration change to conventional manufacturing equipment is to add a second reel of magnetic stripe material for each row of cards. The remainder of the card manufacturing process remains the same as for conventional single-account transaction cards.

Various modifications, substitutions, and changes may be made in the structure and embodiments shown without departing from the concept of the invention. Therefore, the scope of the invention is to be determined by the terminology of the following claims and the legal equivalents thereof.

1) A transaction card usable on conventional card readers comprising:
a plate member having a front face and a rear face;
a first embossed information section disposed on the front face and corresponding to a first transaction account;
a second embossed information section disposed on the front face and corresponding to a second transaction account;
a third embossed information section disposed on said front face and corresponding to both said first transaction account and said second transaction account;
a first magnetic stripe disposed on said rear face and corresponding to said first transaction account;
a second magnetic stripe disposed on said rear face and corresponding to said second transaction account;
a single signature block disposed on said rear face;
with each of the first, second, and third embossed information sections being placed and arranged on said plate member so that none of the first, second or third embossed information sections interferes with any of the first or second magnetic stripes or the signature block.

2) The transaction card of claim 1 wherein each embossed information section is comprised entirely of embossed characters having a size of ten characters per inch.

3) The transaction card of claim 1 wherein the first embossed information section is disposed on said front face adjacent to and below the vertical position of the first magnetic stripe,
the signature bar is disposed on said rear face adjacent to and below the vertical position of the first embossed information section,
the second embossed information section is disposed on said front face adjacent to and below the vertical position of the signature bar,
the second magnetic stripe is disposed on said rear face adjacent to and below the vertical position of the second embossed information section.

4) The transaction card of claim 1 wherein said first magnetic stripe includes a first holographic indicia denoting association with the first transaction account, and said second magnetic stripe includes a second holographic indicia denoting association with said second transaction account.
